(19) United States
(12) Patent Application Publication
(10) Pub. No.: US 2025/0192240 A1
(43) Pub. Date: Jun. 12, 2025

(54) AQUEOUS ELECTROLYTE COMPOSITION, AQUEOUS ELECTROLYTE, AND ZINC ION SECONDARY BATTERY INCLUDING THE SAME

(71) Applicant: National Kaohsiung University of Science and Technology, Kaohsiung (TW)

(72) Inventors: Chun-Jern PAN, Kaohsiung (TW); Bing-Joe HWANG, Taipei City (TW); Chun-I LEE, Kaohsiung (TW); Yang-Chih HSUEH, Kaohsiung (TW)

(21) Appl. No.: 18/390,991

(22) Filed: Dec. 20, 2023

(30) Foreign Application Priority Data
Dec. 6, 2023 (TW) 112147511

(51) Int. Cl. H01M 10/36

(52) U.S. Cl. CPC H01M 10/365

(57) ABSTRACT

An aqueous electrolyte composition includes water and a salt component containing zinc chloride and manganese (II) acetate. The zinc chloride is present in an amount ranging from 10 moles to 30 moles, based on 1 kilogram of the water. An aqueous electrolyte formed by mixing the water and the salt component of the aqueous electrolyte composition to undergo a solvation process, and a zinc ion secondary battery including the aqueous electrolyte are also provided.

### CROSS-REFERENCE TO RELATED APPLICATION

This application claims priority to Taiwanese Invention patent application No. 112147511, filed on Dec. 6, 2023, and incorporated by reference herein in its entirety.

### FIELD

The present disclosure relates to an aqueous electrolyte composition, and more particularly to an aqueous electrolyte composition suitable for use as an aqueous electrolyte, and a zinc ion secondary battery including the aqueous electrolyte.

### BACKGROUND

A conventional aqueous zinc ion secondary battery includes a manganese positive electrode, a negative electrode, a separator, and an aqueous electrolyte, and has the advantages of high energy density, high safety, and low manufacturing cost. However, during charging and discharging cycles of the conventional aqueous zinc ion secondary battery, zinc dendrites that accumulate and grow on the negative electrode may penetrate the separator, causing a short circuit of the conventional aqueous zinc ion secondary battery. In addition, an irreversible dissolution of manganese from the manganese positive electrode into the aqueous electrolyte may result in a structural collapse of the manganese positive electrode, thereby declining the overall efficiency and shortening the lifespan of the conventional aqueous zinc ion secondary battery.

Current methods to address the aforesaid issues include subjecting the negative electrode or the manganese positive electrode to a surface treatment, and introducing organic compounds into the aqueous electrolyte to protect the negative electrode. However, the surface treatment of the negative electrode or the manganese positive electrode is a cumbersome process, and the introduction of the organic compounds into the aqueous electrolyte adversely affects the performance of the conventional aqueous zinc ion secondary battery.

WO 2023140569 A1 discloses an electrolyte for a zinc ion battery. The electrolyte for the zinc ion battery includes a zinc electrolyte and an additive agent containing a manganese salt. The zinc electrolyte is selected from the group consisting of zinc sulfate, zinc chloride, zinc nitrate, zinc chlorate, zinc perchlorate, zinc acetate, zinc bromide, zinc trifluoromethanesulfonate, zinc bis(trifluoromethanesulfonyl)imide, zinc hydroxide, and combinations thereof, and is present in a concentration ranging from 0.5 M to 3 M. The manganese salt is selected from the group consisting of manganese sulfate, manganese carbonate, manganese monoxide, manganese chloride, manganese nitrate, manganese acetate, and combinations thereof, and is present in a concentration ranging from 0.01 M to 0.5 M. The electrolyte for the zinc ion batteries prevents manganese from being dissolved in the zinc electrolyte, thus enhancing structural stability of the positive electrode of the zinc ion battery.

In spite of the aforesaid, there is still a need to develop an aqueous electrolyte composition suitable for use as an aqueous electrolyte, and a zinc ion secondary battery including the same, which can effectively reduce the accumulation of zinc dendrite and the irreversible dissolution of manganese.

### SUMMARY

Therefore, in a first aspect, the present disclosure provides an aqueous electrolyte composition, which can alleviate at least one of the drawbacks of the prior art. The aqueous electrolyte composition includes water and a salt component containing zinc chloride and manganese (II) acetate. The zinc chloride is present in an amount ranging from 10 moles to 30 moles, based on 1 kilogram of the water.

In a second aspect, the present disclosure provides an aqueous electrolyte formed by mixing the water and the salt component of the aforesaid aqueous electrolyte composition to undergo a solvation process, which can alleviate at least one of the drawbacks of the prior art. The aqueous electrolyte includes: [Zn(H₂O)₆]²⁺ ion cluster; [ZnCl₂₊ₓ(H₂O)ₙ]^{x-} ion cluster, wherein x represents an integer ranging from 0 to 3, and n represents an integer ranging from 1 to 4; and [Mn(CH₃COO)_{2+y}(H₂O)ₘ]^{y-} ion cluster, wherein y represents an integer ranging from 0 to 3, and m represents an integer ranging from 1 to 4.

In a third aspect, the present disclosure provides a zinc ion secondary battery, which can alleviate at least one of the drawbacks of the prior art. The zinc ion secondary battery includes a manganese positive electrode, a negative electrode spaced apart from the manganese positive electrode, and the aforesaid aqueous electrolyte in contact with the manganese positive electrode and the negative electrode.

In a fourth aspect, the present disclosure provides another aqueous electrolyte composition, which can alleviate at least one of the drawbacks of the prior art. The aqueous electrolyte composition includes water, and a salt component containing zinc chloride, manganese (II) salt, and acetate. The acetate is selected from the group consisting of sodium acetate, potassium acetate, lithium acetate, magnesium acetate, calcium acetate, and combinations thereof. The manganese (II) salt is selected from the group consisting of manganese (II) chloride, manganese nitrate, manganese sulfate, manganese (II) perchlorate, manganese (II) bis(trifluoromethanesulfonyl)imide, and combinations thereof. The zinc chloride is present in an amount ranging from 10 moles to 30 moles, based on 1 kilogram of the water.

In a fifth aspect, the present disclosure provides another aqueous electrolyte formed by mixing the water and the salt component of the aforesaid another aqueous electrolyte composition to undergo a solvation process, which can alleviate at least one of the drawbacks of the prior art. The aqueous electrolyte includes: [Zn(H₂O)₆]²⁺ ion cluster; [ZnCl₂₊ₓ(H₂O)ₙ]^{x-} ion cluster, wherein X represents an integer ranging from 0 to 3, and n represents an integer ranging from 1 to 4; and [Mn(CH₃COO)_{2+y}(H₂O)ₘ]^{y-} ion cluster, wherein y represents an integer ranging from 0 to 3, and m represents an integer ranging from 1 to 4.

In a sixth aspect, the present disclosure provides another zinc ion secondary battery, which can alleviate at least one of the drawbacks of the prior art. The zinc ion secondary battery includes a manganese positive electrode, a negative electrode spaced apart from the manganese positive electrode, and the aforesaid another aqueous electrolyte in contact with the manganese positive electrode and the negative electrode.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 shows the Raman spectra of the aqueous electrolytes of Examples 1 to 5 (i.e., EX1 to EX5), and Comparative Example 1 (i.e., CE1) in Raman shift region from 175 cm⁻¹ to 1200 cm⁻¹.

FIG. 2 shows the Raman spectra of the aqueous electrolytes of Examples 8 and 9 (i.e., EX8 and EX9), and Comparative Example 1 (i.e., CE1) in Raman shift region from 175 cm⁻¹ to 1200 cm⁻¹.

FIG. 3 shows the Raman spectra of the aqueous electrolytes of Comparative Examples 1 to 6 (i.e., CE1 to CE6) in Raman shift region from 175 cm⁻¹ to 1200 cm⁻¹.

FIG. 4 shows the Raman spectra of the aqueous electrolytes of Comparative Example 1, and Comparative Examples 7 to 9 (i.e., CE1 and CE7 to CE9) in Raman shift region from 175 cm⁻¹ to 1200 cm⁻¹.

FIG. 5 shows the Raman spectra of the aqueous electrolytes of Comparative Examples 10 to 16 (CE10 to CE16) in Raman shift region from 175 cm⁻¹ to 1200 cm⁻¹.

FIG. 6 is a graph showing the performance data of the zinc ion secondary battery of Example 1 (i.e., EX1).

FIG. 7 is a graph showing the performance data of the zinc ion secondary battery of Example 2 (i.e., EX2).

FIG. 8 is a graph showing the performance data of the zinc ion secondary battery of Example 3 (i.e., EX3).

FIG. 9 is a graph showing the performance data of the zinc ion secondary battery of Example 4 (i.e., EX4).

FIG. 10 is a graph showing the performance data of the zinc ion secondary battery of Example 5 (i.e., EX5).

FIG. 11 is a graph showing the performance data of the zinc ion secondary battery of Example 6 (i.e., EX6).

FIG. 12 is a graph showing the performance data of the zinc ion secondary battery of Example 7 (i.e., EX7).

FIG. 13 is a graph showing the performance data of the zinc ion secondary battery of Example 8 (i.e., EX8).

FIG. 14 is a graph showing the performance data of the zinc ion secondary battery of Example 9 (i.e., EX9).

FIG. 15 is a graph showing the performance data of the zinc ion secondary battery of Comparative Example 1 (i.e., CE1).

FIG. 16 is a graph showing the performance data of the zinc ion secondary battery of Comparative Example 2 (i.e., CE2).

FIG. 17 is a graph showing the performance data of the zinc ion secondary battery of Comparative Example 3 (i.e., CE3).

FIG. 18 is a graph showing the performance data of the zinc ion secondary battery of Comparative Example 4 (i.e., CE4).

FIG. 19 is a graph showing the performance data of the zinc ion secondary battery of Comparative Example 5 (i.e., CE5).

FIG. 20 is a graph showing the performance data of the zinc ion secondary battery of Comparative Example 6 (i.e., CE6).

FIG. 21 is a graph showing the performance data of the zinc ion secondary battery of Comparative Example 7 (i.e., CE7).

FIG. 22 is a graph showing the performance data of the zinc ion secondary battery of Comparative Example 8 (i.e., CE8).

FIG. 23 is a graph showing the performance data of the zinc ion secondary battery of Comparative Example 9 (i.e., CE9).

FIG. 24 is a graph showing the performance data of the zinc ion secondary battery of Comparative Example 10 (i.e., CE10).

FIG. 25 is a graph showing the performance data of the zinc ion secondary battery of Comparative Example 11 (i.e., CE11).

FIG. 26 is a graph showing the performance data of the zinc ion secondary battery of Comparative Example 12 (i.e., CE12).

FIG. 27 is a graph showing the performance data of the zinc ion secondary battery of Comparative Example 13 (i.e., CE13).

FIG. 28 is a graph showing the performance data of the zinc ion secondary battery of Comparative Example 14 (i.e., CE14).

FIG. 29 is a graph showing the performance data of the zinc ion secondary battery of Comparative Example 15 (i.e., CE15).

FIG. 30 is a graph showing the performance data of the zinc ion secondary battery of Comparative Example 16 (i.e., CE16).

### DETAILED DESCRIPTION

For the purpose of this specification, it will be clearly understood that the word “comprising” means “including but not limited to”, and that the word “comprises” has a corresponding meaning.

It is to be understood that, if any prior art publication is referred to herein, such reference does not constitute an admission that the publication forms a part of the common general knowledge in the art, in Taiwan or any other country.

Unless defined otherwise, all technical and scientific terms used herein have the meaning commonly understood by a person skilled in the art to which the present disclosure belongs. One skilled in the art will recognize many methods and materials similar or equivalent to those described herein, which could be used in the practice of the present disclosure. Indeed, the present disclosure is in no way limited to the methods and materials described.

### First Embodiment of Aqueous Electrolyte Composition

A first embodiment of an aqueous electrolyte composition according to the present disclosure includes water and a salt component containing zinc chloride and manganese (II) acetate [Mn(CH₃COO)₂].

According to the present disclosure, the zinc chloride is present in an amount ranging from 10 moles to 30 moles, based on 1 kilogram of the water. In certain embodiments, the zinc chloride is present in an amount ranging from 19 moles to 30 moles, based on 1 kilogram of the water. In an exemplary embodiment, the zinc chloride is present in an amount of 19 moles, based on 1 kilogram of the water.

According to the present disclosure, the manganese (II) acetate is present in an amount ranging from 0.5 moles to 5.0 moles, based on 1 kilogram of the water. In certain embodiments, the manganese (II) acetate is present in an amount ranging from 1 mole to 5 moles, based on 1 kilogram of the water. In certain embodiments, the manganese (II) acetate is present in an amount ranging from 1 mole to 3 moles, based on 1 kilogram of the water. In other embodiments, the manganese (II) acetate is present in an amount ranging from 1 mole to 2 moles, based on 1 kilogram of the water.

### First Embodiment of Aqueous Electrolyte

A first embodiment of an aqueous electrolyte according to the present disclosure is formed by mixing the water and the salt component of the first embodiment of the aqueous electrolyte composition to undergo a solvation process, and includes: acetate ion (CH₃COO⁻); [Zn(H₂O)₆]²⁺ ion cluster; [ZnCl₂₊ₓ(H₂O)ₙ]^{x-} ion cluster, wherein x represents an integer ranging from 0 to 3, and n represents an integer ranging from 1 to 4; and [Mn(CH₃COO)_{2+y}(H₂O)ₘ]^{y-} ion cluster, wherein y represents an integer ranging from 0 to 3, and m represents an integer ranging from 1 to 4.

As used herein, the term “solvation” refers to an attraction of solvent molecules with molecules or ions of a solute, so as to form a solvation shell.

According to the present disclosure, in the first embodiment of the aqueous electrolyte, the zinc chloride has a molality ranging from 10 mole/kg to 30 mole/kg. In certain implementations of the first embodiment of the aqueous electrolyte, the zinc chloride has a molality ranging from 19 mole/kg to 30 mole/kg. In an exemplary implementation of the first embodiment of the aqueous electrolyte, the zinc chloride has a molality of 19 mole/kg.

According to the present disclosure, in the first embodiment of the aqueous electrolyte, the manganese (II) acetate has a molality ranging from 0.5 mole/kg to 5.0 mole/kg. In certain implementations of the first embodiment of the aqueous electrolyte, the manganese (II) acetate has a molality ranging from 1 mole/kg to 5 mole/kg. In certain implementations of the first embodiment of the aqueous electrolyte, the manganese (II) acetate has a molality ranging from 1 mole/kg to 3 mole/kg. In other implementations of the first embodiment of the aqueous electrolyte, the manganese (II) acetate has a molality ranging from 1 mole/kg to 2 mole/kg.

To be specific, the first embodiment of the aqueous electrolyte is form by mixing the water and the salt component containing the zinc chloride and the manganese (II) acetate to undergo a solvation process. By virtue of the zinc chloride being present in an amount as high as 10 moles to 30 moles based on 1 kilogram of the water, the zinc chloride and the manganese (II) acetate may be dissolved in the water and subsequently form new coordinate bonds with water molecules, and thus almost all of the water molecules engage in the solvation process with the zinc chloride and the manganese (II) acetate, resulting in the first embodiment of the aqueous electrolyte being predominantly made up of the aforesaid ion and ion clusters with relatively few free water molecules.

In certain embodiments, the acetate ion in the first embodiment of the aqueous electrolyte originates from the manganese (II) acetate and does not participate in the aforesaid coordination.

In certain embodiments, the [Mn(CH₃COO)_{2+y}(H₂O)ₘ]^{y-} ion cluster is formed by the coordination of the acetate ion and manganese ion (Mn²⁺), both of which originate from the manganese (II) acetate, with the water molecules.

In certain embodiments, the [ZnCl₂₊ₓ(H₂O)ₙ]^{x-} ion cluster is formed by the coordination of the zinc chloride with the water molecules.

In certain embodiments, the [Zn(H₂O)₆]²⁺ ion cluster is formed by the coordination of zinc ion originating from the zinc chloride with the water molecules.

### First Embodiment of Zinc Ion Secondary Battery

A first embodiment of a zinc ion secondary battery according to the present disclosure includes a manganese positive electrode, a negative electrode spaced apart from the manganese positive electrode, a separator disposed between the manganese positive electrode and the negative electrode, and the first embodiment of the aqueous electrolyte in contact with the manganese positive electrode and the negative electrode.

According to the present disclosure, the manganese positive electrode includes a current collector and an active layer disposed on a surface of the current collector. In certain embodiments, the active layer is formed by subjecting a paste which includes a manganese dioxide powder, a conductive powder, and an adhesive agent to a drying treatment. Examples of the current collector may include, but are not limited to, a carbon fiber paper, a carbon felt, a titanium foil, or a tungsten foil. Examples of the manganese dioxide powder in crystallized powder form may include, but are not limited to, α-MnO₂, β-MnO₂, δ-MnO₂, γ-MnO₂, λ-MnO₂, or R-MnO₂. Examples of the conductive powder may include, but are not limited to, carbon black Super P, acetylene black, or Ketjenblack. Examples of the adhesive agent may include, but are not limited to, a polyvinylidene difluoride (PVDF) adhesive agent, a polytetrafluoroethylene (PTFE) adhesive agent, or a carboxymethyl cellulose (CMC) adhesive agent.

According to the present disclosure, the negative electrode is a metal sheet and is selected from the group consisting of a zinc negative electrode, a copper negative electrode, a lead negative electrode, a tungsten negative electrode, and an indium negative electrode.

According to the present disclosure, the separator may be a glass fiber separator.

### Second Embodiment of Aqueous Electrolyte Composition

A second embodiment of an aqueous electrolyte composition according to the present disclosure includes water and a salt component containing zinc chloride, manganese (II) salt, and acetate.

According to the present disclosure, the acetate is selected from the group consisting of sodium acetate, potassium acetate, lithium acetate, magnesium acetate, calcium acetate, and combinations thereof.

According to the present disclosure, the manganese (II) salt is selected from the group consisting of manganese (II) chloride (MnCl₂), manganese nitrate, manganese sulfate, manganese (II) perchlorate [Mn(ClO₄)₂], manganese (II) bis(trifluoromethanesulfonyl)imide [Mn(TFSI)₂], and combinations thereof.

According to the present disclosure, the zinc chloride is present in an amount ranging from 10 moles to 30 moles, based on 1 kilogram of the water. In certain embodiments, the zinc chloride is present in an amount ranging from 19 moles to 30 moles, based on 1 kilogram of the water. In an exemplary embodiment, the zinc chloride is present in an amount of 19 moles, based on 1 kilogram of the water.

According to the present disclosure, the acetate is present in an amount ranging from 1 mole to 10 moles, based on 1 kilogram of the water. In certain embodiments, the acetate is present in an amount ranging from 2 moles to 4 moles, based on 1 kilogram of the water.

According to the present disclosure, the manganese (II) salt is present in an amount ranging from 0.5 moles to 5.0 moles, based on 1 kilogram of the water. In certain embodiments, the manganese (II) salt is present in an amount ranging from 0.5 moles to 1.0 mole, based on 1 kilogram of the water.

### Second Embodiment of Aqueous Electrolyte

A second embodiment of an aqueous electrolyte according to the present disclosure is formed by mixing the water and the salt component of the second embodiment of the aqueous electrolyte composition to undergo a solvation process, and includes: acetate ion (CH₃COO⁻); [Zn(H₂O)₆]²⁺ ion cluster; [ZnCl₂₊ₓ(H₂O)ₙ]^{x-} ion cluster, wherein x represents an integer ranging from 0 to 3, and n represents an integer ranging from 1 to 4; and [Mn(CH₃COO)_{2+y}(H₂O)ₘ]^{y-} ion cluster, wherein y represents an integer ranging from 0 to 3, and m represents an integer ranging from 1 to 4.

According to the present disclosure, in the second embodiment of the aqueous electrolyte, the zinc chloride has a molality ranging from 10 mole/kg to 30 mole/kg. In certain implementations of the second embodiment of the aqueous electrolyte, the zinc chloride has a molality ranging from 19 mole/kg to 30 mole/kg. In an exemplary implementation of the second embodiment of the aqueous electrolyte, the zinc chloride has a molality of 19 mole/kg.

According to the present disclosure, in the second embodiment of the aqueous electrolyte, the acetate has a molality ranging from 1 mole/kg to 10 mole/kg. In certain implementations of the second embodiment of the aqueous electrolyte, the acetate has a molality ranging from 2 mole/kg to 4 mole/kg.

According to the present disclosure, in the second embodiment of the aqueous electrolyte, the manganese (II) salt has a molality ranging from 0.5 mole/kg to 5.0 mole/kg. In certain implementations of the second embodiment of the aqueous electrolyte, the manganese (II) salt has a molality ranging from 0.5 mole/kg to 1.0 mole/kg.

To be specific, the second embodiment of the aqueous electrolyte is form by mixing the water and the salt component containing the zinc chloride, the manganese (II) salt, and the acetate to undergo a solvation process. By virtue of the zinc chloride being present in an amount as high as 10 moles to 30 moles based on 1 kilogram of the water, the zinc chloride, the manganese (II) salt, and the acetate may be dissolved in the water and subsequently form new coordinate covalent bonds with water molecules, and thus almost all of the water molecules engage in the solvation process with the zinc chloride, the manganese (II) salt, and the acetate, resulting in the second embodiment of the aqueous electrolyte being predominantly made up of the aforesaid ion and ion clusters with relatively few free water molecules.

In certain embodiments, the acetate ion in the second embodiment of the aqueous electrolyte originates from the acetate and does not participate in the aforesaid coordination.

In certain embodiments, the [Mn(CH₃COO)_{2+y}(H₂O)ₘ]^{y-} ion cluster is formed by the coordination of the acetate ion originating from the acetate and manganese ion (Mn²⁺) originating from the manganese (II) salt with the water molecules.

### Second Embodiment of Zinc Ion Secondary Battery

A second embodiment of a zinc ion secondary battery according to the present disclosure includes a manganese positive electrode, a negative electrode spaced apart from the manganese positive electrode, a separator disposed between the manganese positive electrode and the negative electrode, and the second embodiment of the aqueous electrolyte in contact with the manganese positive electrode and the negative electrode.

According to the present disclosure, the manganese positive electrode includes a current collector and an active layer disposed on a surface of the current collector. In certain embodiments, the active layer is formed by subjecting a paste which includes a manganese dioxide powder, a conductive powder, and an adhesive agent to a drying treatment. Examples of the current collector may include, but are not limited to, a carbon fiber paper, a carbon felt, a titanium foil, or a tungsten foil. Examples of the manganese dioxide powder in crystallized powder form may include, but are not limited to, α-MnO₂, β-MnO₂, δ-MnO₂, γ-MnO₂, λ-MnO₂, or R-MnO₂. Examples of the conductive powder may include, but are not limited to, carbon black Super P, acetylene black, or Ketjenblack. Examples of the adhesive agent may include, but are not limited to, a polyvinylidene difluoride (PVDF) adhesive agent, a polytetrafluoroethylene (PTFE) adhesive agent, or a carboxymethyl cellulose (CMC) adhesive agent.

According to the present disclosure, the negative electrode is a metal sheet and is selected from the group consisting of a zinc negative electrode, a copper negative electrode, a lead negative electrode, a tungsten negative electrode, and an indium negative electrode.

According to the present disclosure, the separator may be a glass fiber separator.

### Electrochemical Reaction Mechanisms of Zinc Ion Secondary Battery During Charge and Discharge

According to the present disclosure, the electrochemical reaction mechanisms of each of the aforesaid first embodiment of the zinc ion secondary battery and the aforesaid second embodiment of the zinc ion secondary battery during charge include the following Schemes 1 to 3:
(1) In Scheme 1, the manganese positive electrode of the zinc ion secondary battery undergoes an oxidation reaction during the charge, wherein at the beginning of the charge, zinc ion (Zn²⁺) is extracted from the manganese positive electrode;
(2) In Scheme 2, when the zinc ion secondary battery is charged to a high voltage (approximately 1.8 V), the [Mn(CH₃COO)_{2+y}(H₂O)ₘ]^{y-} ion cluster (in which, y represents an integer of 0 and m represents an integer of 4) undergoes a desolvation process on a surface of the manganese positive electrode of the zinc ion secondary battery, thereby disrupting the solvation shell, and thus releasing manganese ion (Mn²⁺), the water molecules (H₂O), and acetate ions (CH₃COO⁻); and
(3) In Scheme 3, the manganese ion (Mn²⁺) reacts with the water molecules (H₂O) to form a solid-state manganese dioxide (MnO₂), which is then deposited on the surface of the manganese positive electrode of the zinc ion secondary battery.

According to the present disclosure, the electrochemical reaction mechanisms of each of the aforesaid first embodiment of the zinc ion secondary battery and the aforesaid second embodiment of the zinc ion secondary battery during discharge include the following Schemes 4 to 5:
(1) In Scheme 4, when the manganese positive electrode of the zinc ion secondary battery undergoes a reduction reaction during the discharge, the solid-state manganese dioxide (MnO₂) dissolves to form manganese ion (Mn²⁺) back into the aqueous electrolyte; and
(2) In Scheme 5, meanwhile, the zinc ion (Zn²⁺) extracted from the manganese positive electrode in Scheme 1 is embedded back into the manganese positive electrode of the zinc ion secondary battery.

The detailed information of Schemes 1 to 3 during the charge and Schemes 4 to 5 during the discharge is summarized in Table 1.

TABLE 1

| | | |
|---|---|---|
| Charge | Scheme 1 | ZnMn₂^{(III)}O₄₍ₛ₎ → 2Mn^{(IV)}O₂₍ₛ₎ + Zn²⁺_{(aq)} + 2e⁻ |
| | Scheme 2 | [Mn(CH₃COO)₂(H₂O)₄]_{(aq)}→ Mn²⁺_{(aq)} + |
| | | 2CH₃COO⁻_{(aq)} + 4H₂O_{(I)} |
| | Scheme 3 | Mn²⁺ + 2H₂O_{(I)} → Mn^{(IV)}O₂₍ₛ₎ + 4H⁺_{(aq)} + 2e⁻ |
| Discharge | Scheme 4 | Mn^{(IV)}O₂₍ₛ₎ + 4H⁺_{(aq)} + 2e⁻ → Mn²⁺_{(aq)} + 2H₂O_{(I)} |
| | Scheme 5 | 2Mn^{(IV)}O₂₍ₛ₎ + Zn²⁺_{(aq)} + 2e⁻ → ZnMn₂^{(III)}O₄₍ₛ₎ |

According to the present disclosure, by virtue of the specific amounts of the ingredients used in each of the salt components of the aforesaid first embodiment of the aqueous electrolyte composition and the aforesaid second embodiment of the aqueous electrolyte composition, the aqueous electrolyte formed by solvation of the aqueous electrolyte composition includes the [Zn(H₂O)₆]²⁺ ion cluster, [ZnCl₂₊ₓ(H₂O)ₙ]^{x-} ion cluster, and [Mn(CH₃COO)_{2+y}(H₂O)ₘ]^{y-} ion cluster. Moreover, most of the aqueous electrolyte of the present disclosure is made up of the aforesaid ion clusters with relatively few free water molecules, and the [ZnCl₂₊ₓ(H₂O)ₙ]^{x-} ion cluster has a more dominant presence compared to the [Zn(H₂O)₆]²⁺ ion cluster. Due to the low presence of the free water molecules, formation of hydroxide (OH⁻) by electrolysis of the free water molecules on a surface of the negative electrode is reduced, thereby decreasing an irreversible reaction that occurs on the surface of the negative electrode. The irreversible reaction is represented by Scheme 6:

Zn²⁺+2OH⁻→Zn(OH)₂ (6)

where Zn(OH)₂ is a common form of zinc dendrites.

In addition, in a solvation shell of the [ZnCl₂₊ₓ(H₂O)ₙ]^{x-} ion cluster, since the zinc ion (Zn²⁺) forms a coordinate bond with the chloride ion (Cl⁻), there is relatively few water molecules (H₂O) in the aqueous electrolyte of the present disclosure, and thus, a formation of the zinc dendrites can be significantly reduced.

Furthermore, the presence of the [Mn(CH₃COO)_{2+y}(H₂O)ₘ]^{y-} ion cluster not only prevents inhibition of the oxidation and reduction reactions of the manganese positive electrode of the zinc ion secondary battery of the present disclosure by the chloride ion (Cl⁻), but also reduces the irreversible dissolution of the manganese positive electrode, so that the manganese positive electrode exhibits excellent performance.

According to the present disclosure, during the solvation process of the aqueous electrolyte composition, the formation of the [ZnCl₂₊ₓ(H₂O)ₙ]^{x-} ion cluster can effectively reduce the formation of the zinc dendrites. In addition, during the charge, the [Mn(CH₃COO)_{2+y}(H₂O)ₘ]^{y-} ion cluster contributes to the formation and deposition of the solid-state manganese dioxide (MnO₂) on the surface of the manganese positive electrode, thereby reducing the irreversible dissolution of the manganese positive electrode and significantly improving the performance of the manganese positive electrode. Therefore, the thus obtained aqueous electrolyte provides a stable electrochemical environment for the zinc ion secondary battery of the present disclosure, so that the zinc ion secondary battery of the present disclosure exhibits excellent performance and prolonged cycle life.

The disclosure will be further described by way of the following examples. However, it should be understood that the following examples are solely intended for the purpose of illustration and should not be construed as limiting the disclosure in practice.

### EXAMPLES

### Example 1 (EX1)

The materials and the amounts thereof for making the aqueous electrolyte composition of EX1 are shown in Table 1 below.

The aqueous electrolyte of EX1 was prepared by dissolving 19 moles of zinc chloride and 1 mole of manganese (II) acetate (both serving as a salt component) in 1 kilogram of ultrapure water at room temperature (i.e., 25° C.) to undergo a solvation process, so as to obtain the aqueous electrolyte of EX1 with a molality shown in Table 2.

In addition, the zinc ion secondary battery of EX1 was prepared according to the procedures described below. A manganese dioxide positive electrode, a glass fiber separator, a zinc negative electrode, and the aqueous electrolyte of EX1 were assembled at ambient temperature and pressure, so as to obtain the zinc ion secondary battery of EX1 in the form of a pouch cell. The manganese dioxide positive electrode was prepared by mixing β-MnO₂ (serving as a manganese dioxide powder), carbon black Super P (serving as a conductive powder, MTI Corporation, Cat. no. Lib-SP), and a PVDF adhesive agent (serving as an adhesive agent, MTI Corporation, Cat. no. Lib-PVDF) in a weight ratio of 8:1:1 to form a paste, followed by applying the paste to a titanium foil (serving as a current collector), and then subjecting the paste to a drying treatment. The zinc negative electrode was a sheet of metallic zinc.

### Examples 2 to 5 (EX2 to EX5)

The materials and the amounts thereof for making the aqueous electrolyte compositions of EX2 to EX5 and the procedures for preparing the aqueous electrolytes of EX2 to EX5 and the zinc ion secondary batteries of EX2 to EX5 were similar to those of EX1, except that the amount of the manganese (II) acetate in the aqueous electrolyte composition and the molality of the manganese (II) acetate in the aqueous electrolyte were varied as shown in Tables 1 and 2 below.

### Examples 6 to 9 (EX6 to EX9)

The materials and the amounts thereof for making the aqueous electrolyte compositions of EX6 to EX9 and the procedures for preparing the aqueous electrolytes of EX6 to EX9 and the zinc ion secondary batteries of EX6 to EX9 were similar to those of EX1, except that in the salt component, manganese (II) chloride and sodium acetate were used instead of the manganese (II) acetate, and the amounts of the manganese (II) chloride and the sodium acetate in the aqueous electrolyte composition and the molality of the manganese (II) chloride and the sodium acetate in the aqueous electrolyte were varied as shown in Tables 1 and 2 below.

### Comparative Examples 1 to 16 (CE1 to CE16)

The procedures for preparing the aqueous electrolytes of CE1 to CE16 and the zinc ion secondary batteries of CE1 to CE16 were similar to those of EX1, except that the materials and the amounts thereof for making the aqueous electrolyte composition, and the molality of each material in the aqueous electrolyte were varied as shown in Tables 1 and 2 below.

TABLE 1

| | Aqueous electrolyte composition | | | | |
|---|---|---|---|---|---|
| | Salt component | | | | |
| | | Manganese | Manganese | Sodium | Ultrapure |
| | Zinc chloride | (II) acetate | (II) chloride | acetate | water |
| | Amount (mole) | | | | Amount (kg) |
| EX1 | 19 | 1 | — | — | 1 |
| EX2 | 19 | 2 | — | — | 1 |
| EX3 | 19 | 3 | — | — | 1 |
| EX4 | 19 | 4 | — | — | 1 |
| EX5 | 19 | 5 | — | — | 1 |
| EX6 | 19 | — | 0.5 | 2 | 1 |
| EX7 | 19 | — | 0.5 | 4 | 1 |
| EX8 | 19 | — | 1 | 2 | 1 |
| EX9 | 19 | — | 1 | 4 | 1 |
| CE1 | 19 | — | — | — | 1 |
| CE2 | 19 | — | 1 | — | 1 |
| CE3 | 19 | — | 2 | — | 1 |
| CE4 | 19 | — | 3 | — | 1 |
| CE5 | 19 | — | 4 | — | 1 |
| CE6 | 19 | — | 5 | — | 1 |
| CE7 | 19 | — | — | 2 | 1 |
| CE8 | 19 | — | — | 4 | 1 |
| CE9 | 19 | — | — | 6 | 1 |
| CE10 | 2 | — | — | — | 1 |
| CE11 | 2 | 0.1 | — | — | 1 |
| CE12 | 2 | 0.3 | — | — | 1 |
| CE13 | 2 | 0.5 | — | — | 1 |
| CE14 | 2 | — | 0.1 | — | 1 |
| CE15 | 2 | — | 0.3 | — | 1 |
| CE16 | 2 | — | 0.5 | — | 1 |

Note:
The symbol “—” represents not added

TABLE 2

| | Aqueous electrolyte | | | |
|---|---|---|---|---|
| | | Manganese (II) | Manganese (II) | |
| | Zinc chloride | acetate | chloride | Sodium acetate |
| | Molality | Molality | Molality | Molality |
| | (mole/kg) | (mole/kg) | (mole/kg) | (mole/kg) |
| EX1 | 19 | 1 | — | — |
| EX2 | 19 | 2 | — | — |
| EX3 | 19 | 3 | — | — |
| EX4 | 19 | 4 | — | — |
| EX5 | 19 | 5 | — | — |
| EX6 | 19 | — | 0.5 | 2 |
| EX7 | 19 | — | 0.5 | 4 |
| EX8 | 19 | — | 1 | 2 |
| EX9 | 19 | — | 1 | 4 |
| CE1 | 19 | — | — | — |
| CE2 | 19 | — | 1 | — |
| CE3 | 19 | — | 2 | — |
| CE4 | 19 | — | 3 | — |
| CE5 | 19 | — | 4 | — |
| CE6 | 19 | — | 5 | — |
| CE7 | 19 | — | — | 2 |
| CE8 | 19 | — | — | 4 |
| CE9 | 19 | — | — | 6 |
| CE10 | 2 | — | — | — |
| CE11 | 2 | 0.1 | — | — |
| CE12 | 2 | 0.3 | — | — |
| CE13 | 2 | 0.5 | — | — |
| CE14 | 2 | — | 0.1 | — |
| CE15 | 2 | — | 0.3 | — |
| CE16 | 2 | — | 0.5 | — |

Note:
The symbol “—” represents not added

### Property Evaluation

### A. Raman Spectroscopy Analysis

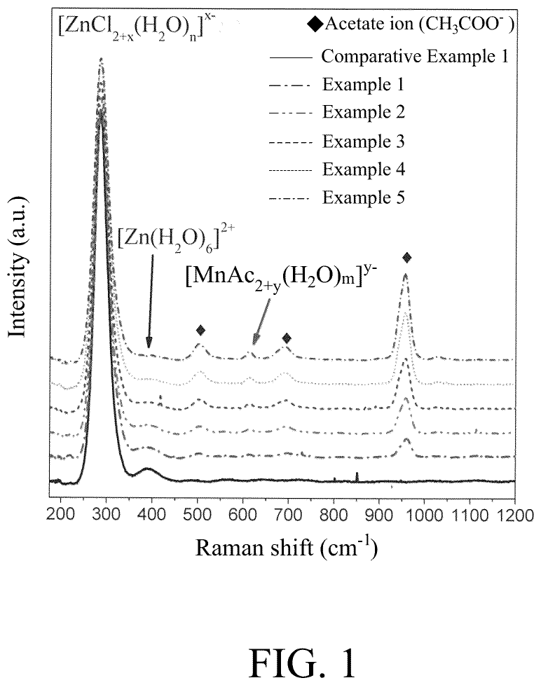

A respective one of the aqueous electrolytes of EX1 to EX5, EX8 to EX9, and CE1 to CE16 was subjected to Raman spectroscopy analysis using a micro Raman spectrometer (Manufacturer: ProTrusTech Co., Ltd.; Model no.: RAMaker). The results are shown in FIGS. 1 to 5.

Publications with regard to Raman spectroscopy have reported that within the range of Raman shift from 175 cm⁻¹ to 1200 cm⁻¹, the characteristic peak at 300 cm⁻¹ was due to the presence of the [ZnCl₂₊ₓ(H₂O)ₙ]^{x-} ion cluster, wherein x represented an integer ranging from 0 to 3, and n represented an integer ranging from 1 to 4. The characteristic peak at 390 cm⁻¹ was due to the presence of the [Zn(H₂O)₆]²⁺ ion cluster. The characteristic peak at 500 cm⁻¹, 690 cm⁻¹, and 960 cm⁻¹ were due to the presence of the acetate ion (CH₃COO⁻). The characteristic peak at 610 cm⁻¹ was due to the presence of the [Mn(CH₃COO)_{2+y}(H₂O)ₘ]^{y-} ion cluster, wherein y represented an integer ranging from 0 to 3, and m represented an integer ranging from 1 to 4.

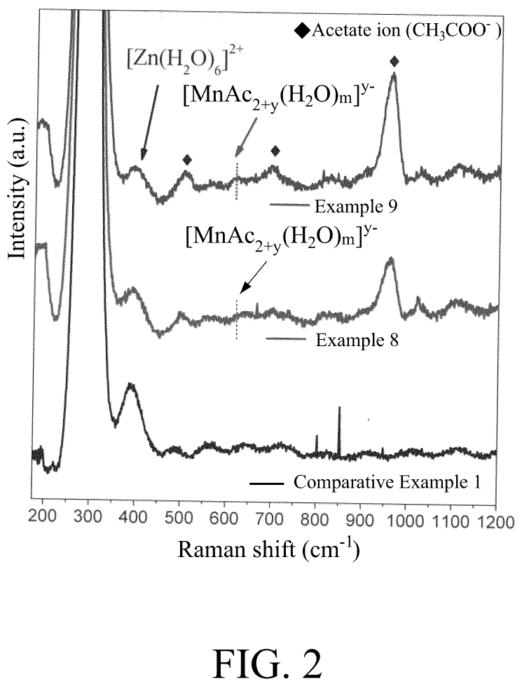

Referring to FIG. 1, in the Raman spectrum of the respective one of the aqueous electrolytes of EX1 to EX5, the characteristic peaks of the [ZnCl₂₊ₓ(H₂O)ₙ]^{x-} ion cluster and the [Mn(CH₃COO)_{2+y}(H₂O)ₘ]^{y-} ion cluster were detected. Referring to FIG. 2, in the Raman spectrum of the respective one of the aqueous electrolytes of EX8 and EX9, the characteristic peaks of the [ZnCl₂₊ₓ(H₂O)ₙ]^{x-} ion cluster and the [Mn(CH₃COO)_{2+y}(H₂O)ₘ]^{y-} ion cluster were detected.

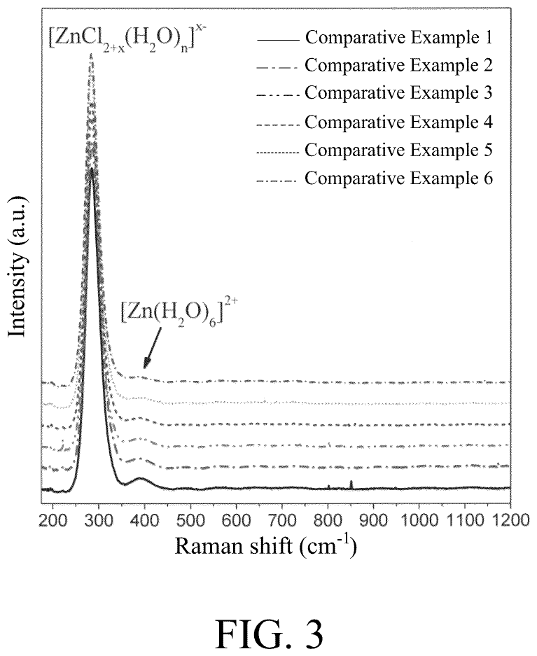

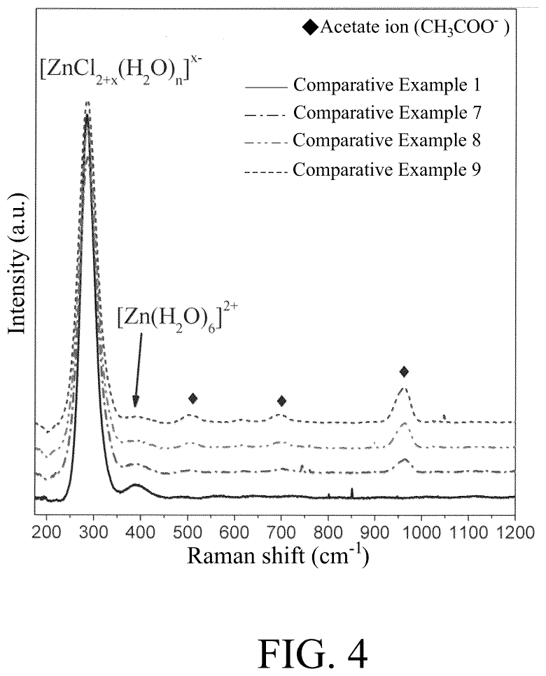

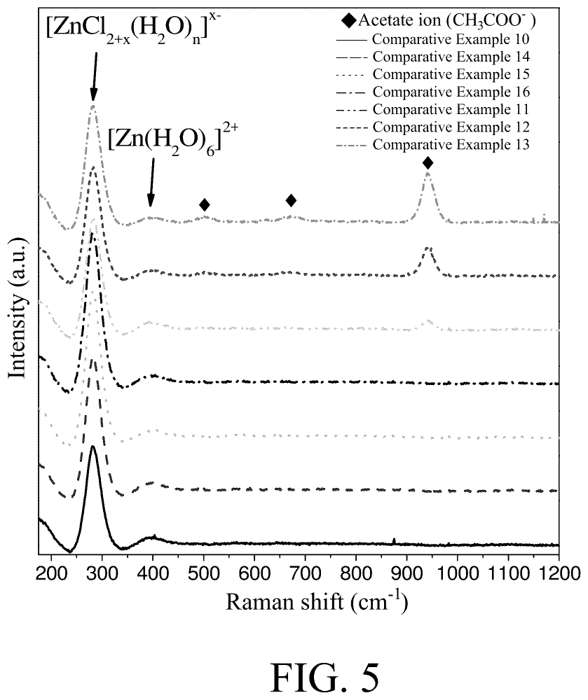

Referring to FIG. 3, in the Raman spectrum of the respective one of the aqueous electrolytes of CE1 to CE6, the characteristic peak of the [Mn(CH₃COO)_{2+y}(H₂O)ₘ]^{y-} ion cluster was not detected. Referring to FIG. 4, in the Raman spectrum of the respective one of the aqueous electrolytes of CE7 to CE9, the characteristic peak of the [Mn(CH₃COO)_{2+y}(H₂O)ₘ]^{y-} ion cluster was not detected. Referring to FIG. 5, in the Raman spectrum of the respective one of the aqueous electrolytes of CE10 to CE16, the characteristic peak of the [Mn(CH₃COO)_{2+y}(H₂O)ₘ]^{y-} ion cluster was not detected, and the characteristic peak of the [ZnCl₂₊ₓ(H₂O)ₙ]^{x-} ion cluster was detected but had a weak intensity.

### B. Zinc Ion Secondary Battery Performance Test

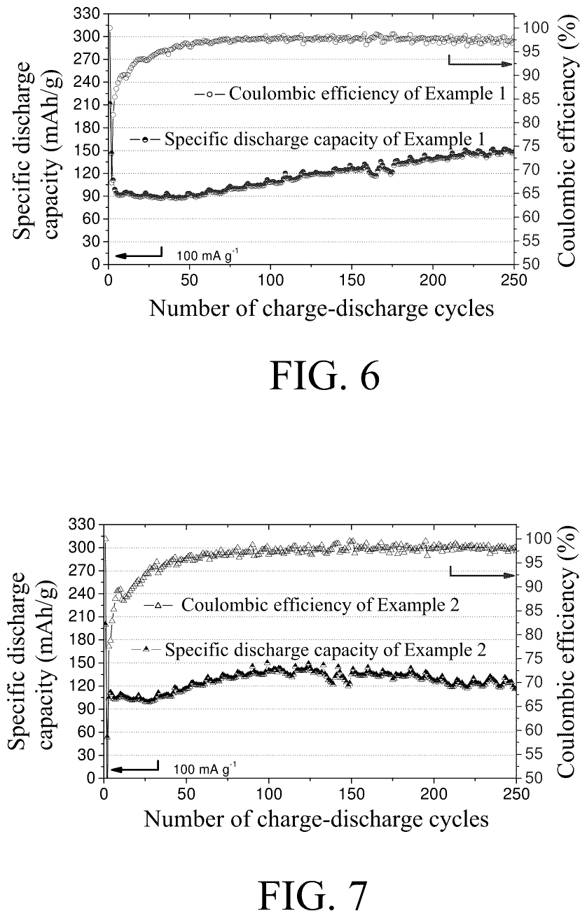

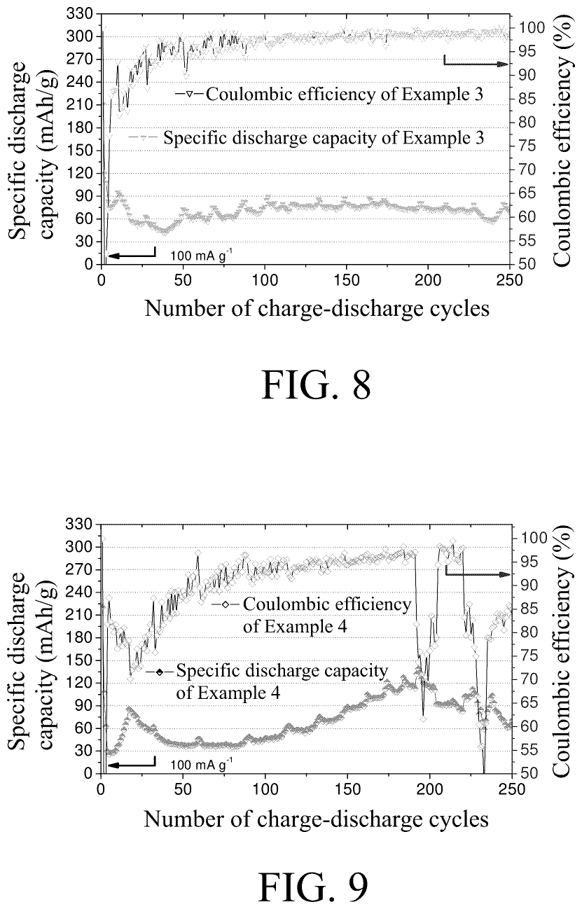

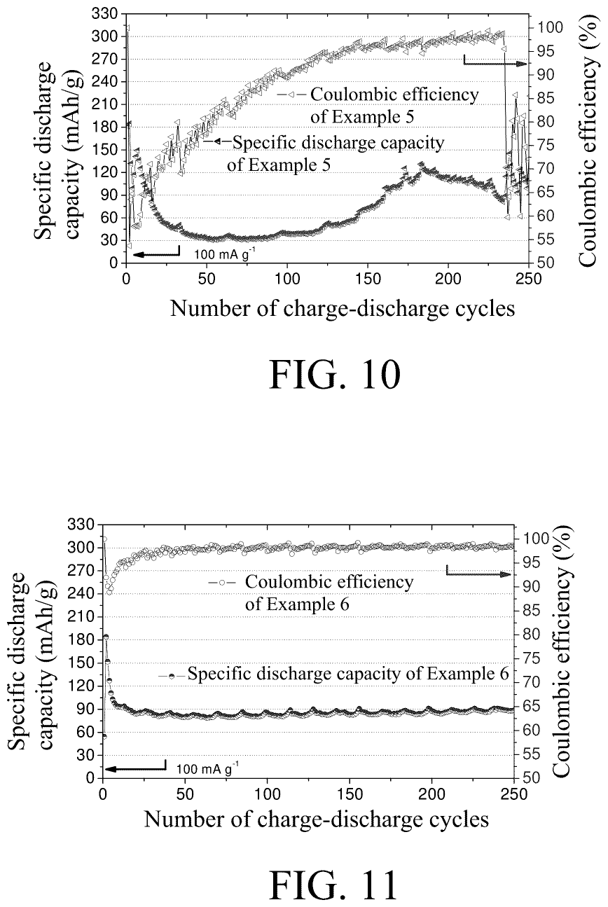

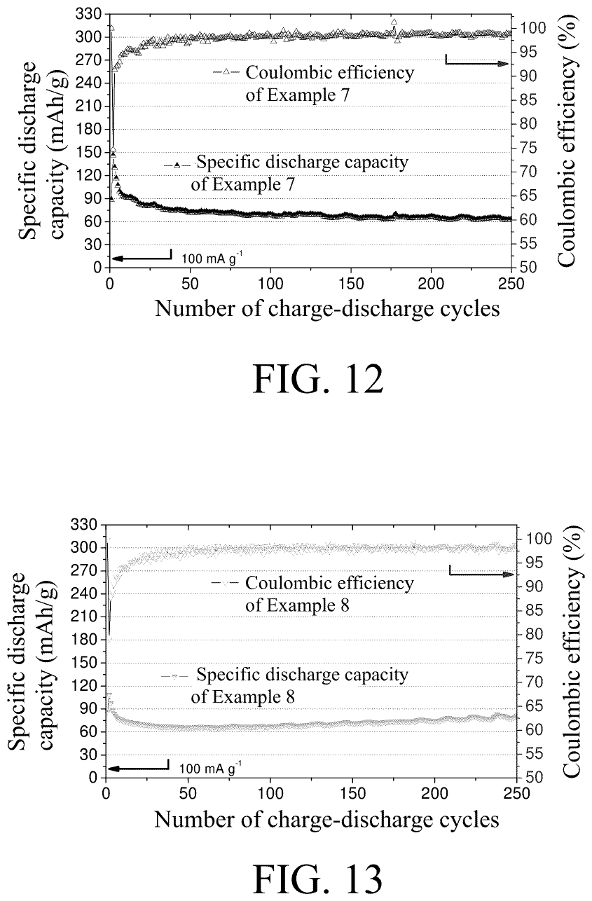

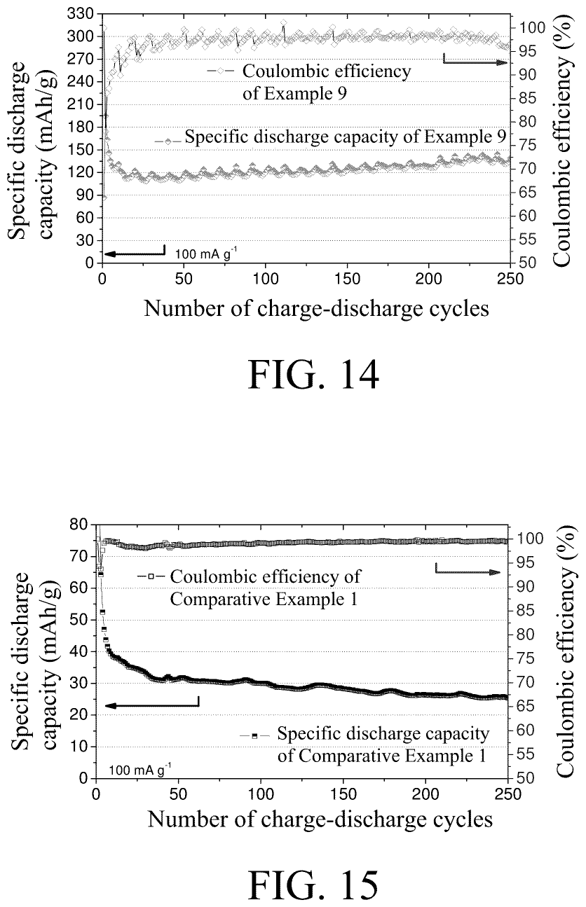

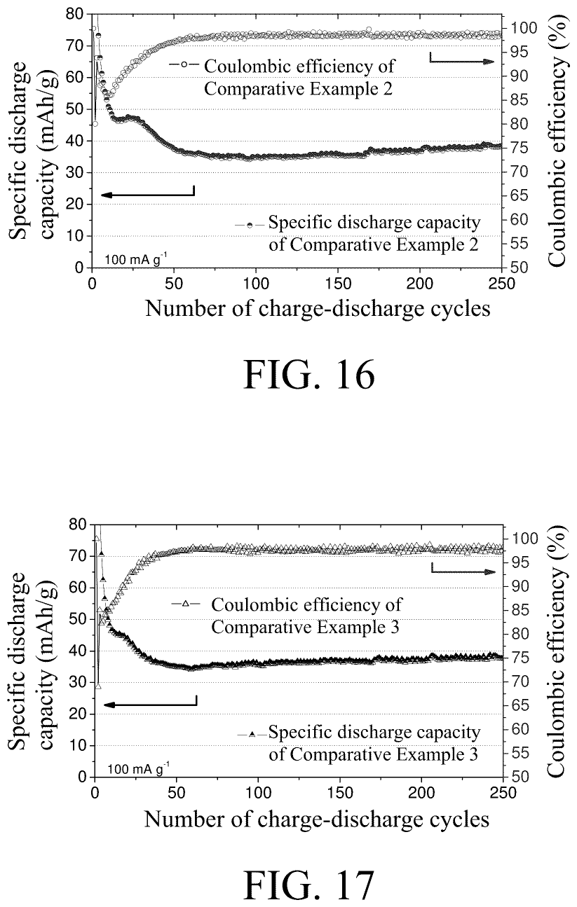

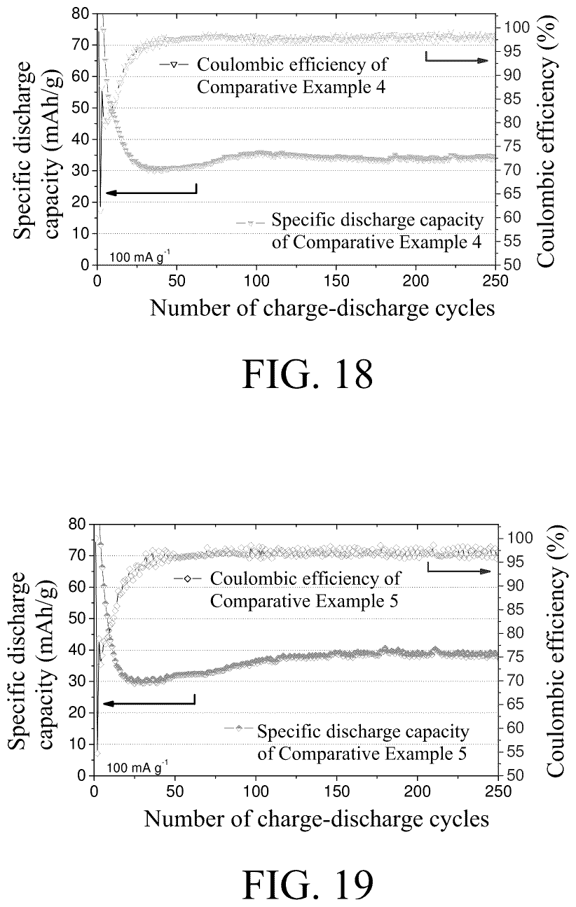

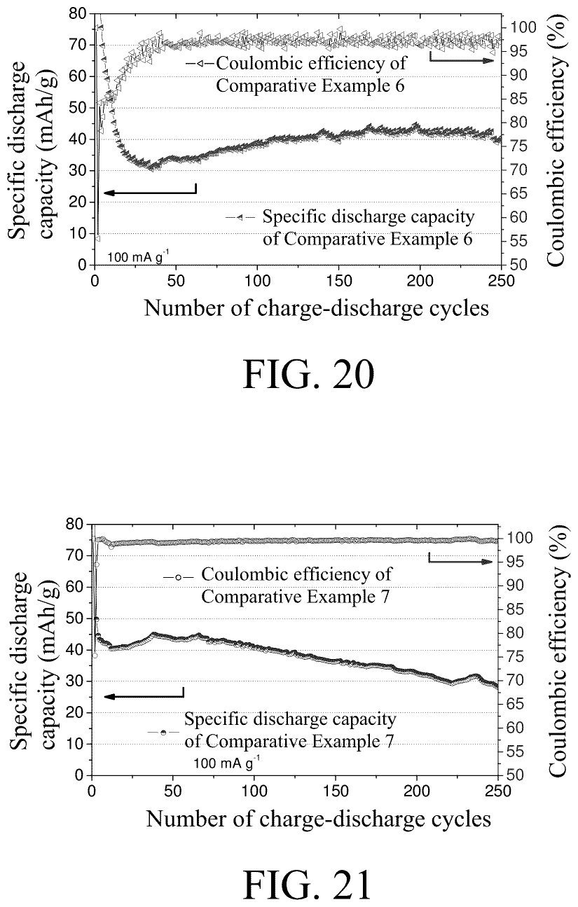

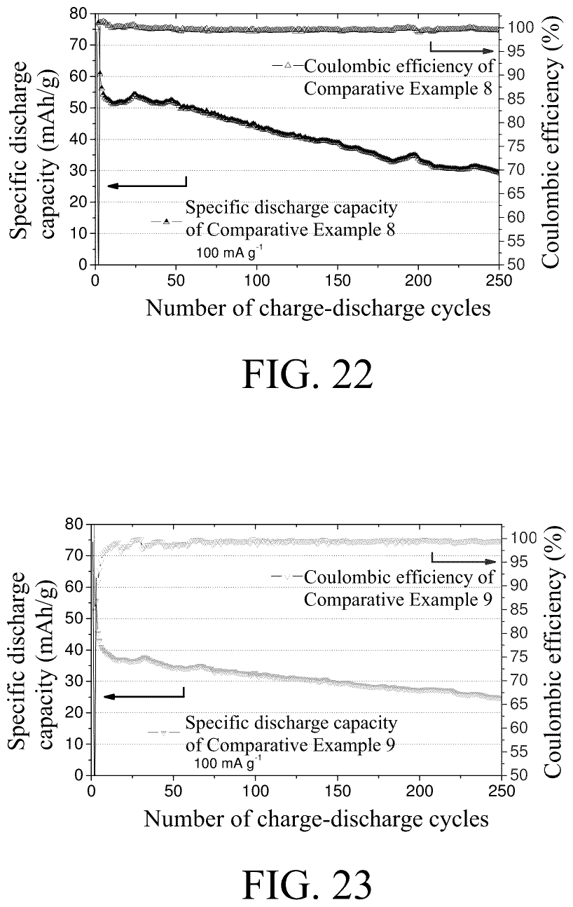

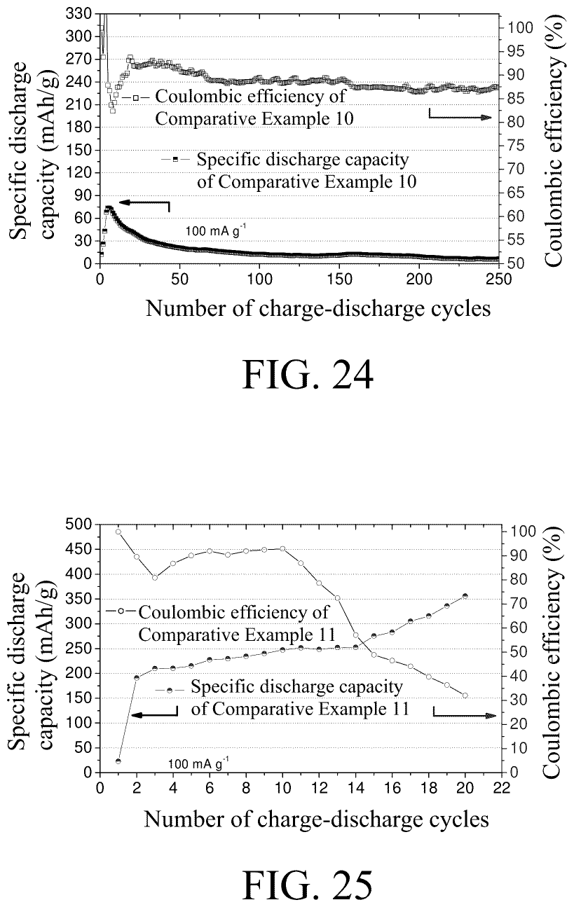

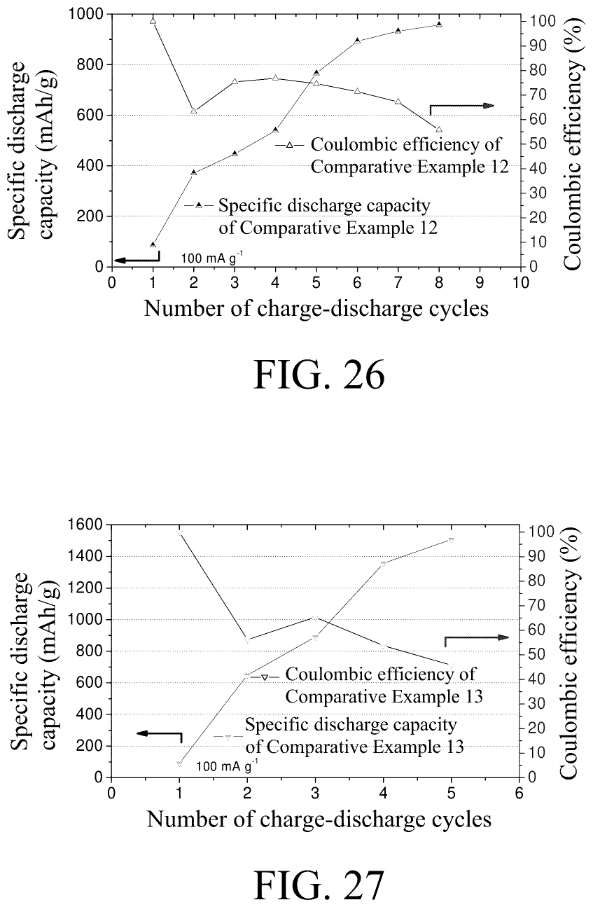

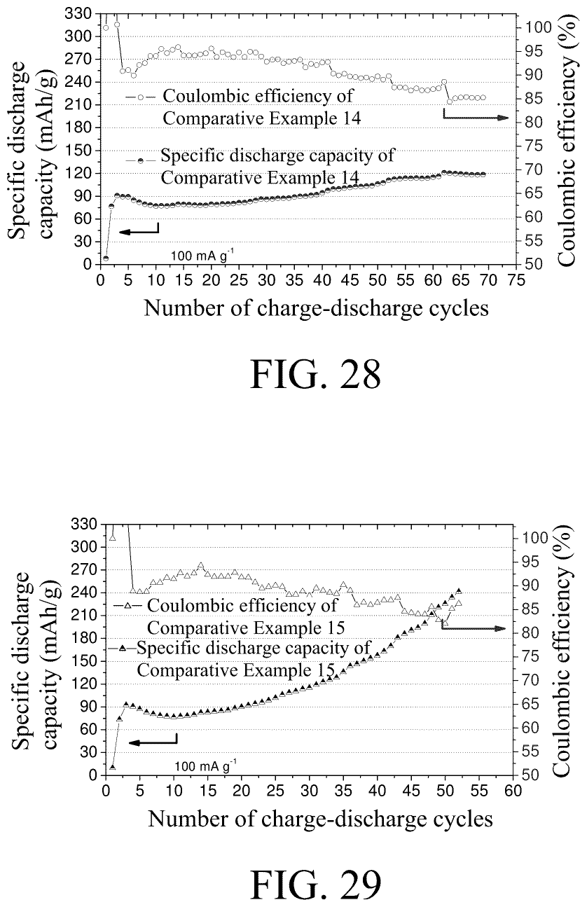

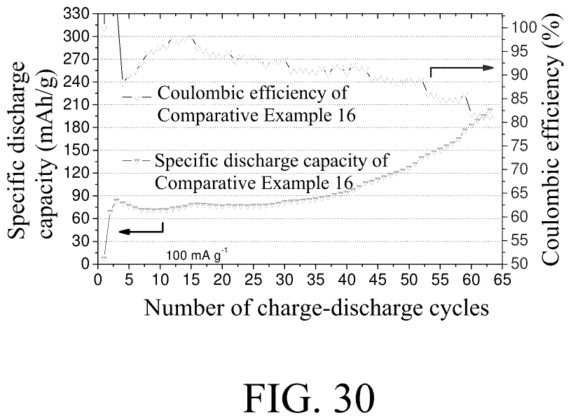

A respective one of the zinc ion secondary batteries of EX1 to EX9 and CE1 to CE16 was subjected to battery charge and discharge test using a battery testing system (Manufacturer: Neware Technology Limited; Model no.: CT-4008-5V20 mA) at an ambient temperature of 27° C., a charge current density of 100 mA/g, a charge cutoff voltage of 1.9 V, a discharge current density of 100 mA/g, a discharge cutoff voltage of 0.8 V and a charge-discharge cycle of 250 cycles. The results are shown in FIGS. 6 to 30.

The coulombic efficiency (%) of the n-cycle, wherein n represented an integer ranging from the 1st cycle to the 250th cycle of the charge-discharge 5 cycle, was calculated using the following Equation (I):

$$A = ( B / C ) \times 100 \% \qquad ( 1 )$$

where A=coulombic efficiency (%) of the n-cycle
   B=specific discharge capacity of the n-cycle
   C=specific charge capacity of the n-cycle

In addition, the average coulombic efficiency (%) was calculated as the average of the coulombic efficiencies from the 50th cycle to the 250th cycle. The results are shown in Table 3 below.

TABLE 3

| | Zinc ion secondary battery |
|---|---|
| | Average coulombic efficiency (%) |
| EX1 | 97.6 |
| EX2 | 97.7 |
| EX3 | 97.9 |
| EX4 | 90.4 |
| EX5 | 91.5 |
| EX6 | 98.3 |
| EX7 | 98.5 |
| EX8 | 98.1 |
| EX9 | 97.9 |
| CE1 | 99.3 |
| CE2 | 98.5 |
| CE3 | 97.7 |
| CE4 | 98.0 |
| CE5 | 97.0 |
| CE6 | 97.2 |
| CE7 | 99.5 |
| CE8 | 99.5 |
| CE9 | 99.4 |
| CE10 | 88.2 |
| CE11 | Due to extremely poor performance by the 20^{th} |
| | cycle, the average coulombic efficiency of CE11 |
| | cannot be calculated. |
| CE12 | Due to extremely poor performance by the 8^{th} |
| | cycle, the average coulombic efficiency of CE12 |
| | cannot be calculated. |
| CE13 | Due to extremely poor performance by the 5^{th} |
| | cycle, the average coulombic efficiency of CE13 |
| | cannot be calculated. |
| CE14 | Due to extremely poor performance by the 70^{th} |
| | cycle, the average coulombic efficiency of CE14 |
| | cannot be calculated. |
| CE15 | Due to extremely poor performance by the 50^{th} |
| | cycle, the average coulombic efficiency of CE15 |
| | cannot be calculated. |
| CE16 | Due to extremely poor performance by the 60^{th} |
| | cycle, the average coulombic efficiency of CE16 |
| | cannot be calculated. |

Referring to Table 3 and FIGS. 6 to 14, the respective one of the zinc ion secondary batteries of EX1 to EX9 showed high coulombic efficiency and high specific discharge capacity, indicating that the respective one of the zinc ion secondary batteries of EX1 to EX9 had good overall efficiency and a good energy storage capacity. In addition, the respective one of the zinc ion secondary batteries of EX1 to EX9 showed no significant degradation in the coulombic efficiency from the 1st cycle to the 250th cycle and in the specific discharge capacity, indicating that the respective one of the zinc ion secondary batteries of EX1 to EX9 had long cycle life.

Referring to Table 3 and FIGS. 15 to 30, the respective one of the zinc ion secondary batteries of CE1 to CE9 showed a low specific discharge capacity, the zinc ion secondary battery of CE10 showed both a low coulombic efficiency and a low specific discharge capacity, and the respective one of the zinc ion secondary batteries of CE11 to CE16 showed a low coulombic efficiency coupled with significant degradation.

Summarizing the above test results, it is clear that compared with the aqueous electrolyte formed from the aqueous electrolyte composition of each of CE1 to CE16, the aqueous electrolyte formed from the aqueous electrolyte composition of the present disclosure (i.e., each of EX1 to EX9) having the [Mn(CH₃COO)_{2+y}(H₂O)ₘ]^{y-} ion cluster enables the zinc ion secondary battery of the present disclosure to have a higher specific discharge capacity, a higher average coulombic efficiency, and a longer cycle life.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. An aqueous electrolyte composition, comprising:
water; and
a salt component which includes zinc chloride and manganese (II) acetate;
wherein the zinc chloride is present in an amount ranging from 10 moles to 30 moles, based on 1 kilogram of the water.

2. The aqueous electrolyte composition according to claim 1, wherein the zinc chloride is present in an amount ranging from 19 moles to 30 moles, based on 1 kilogram of the water.

3. The aqueous electrolyte composition according to claim 1, wherein the manganese (II) acetate is present in an amount ranging from 0.5 moles to 5.0 moles, based on 1 kilogram of the water.

4. The aqueous electrolyte composition according to claim 3, wherein the manganese (II) acetate is present in an amount ranging from 1 mole to 5 moles, based on 1 kilogram of the water.

5. The aqueous electrolyte composition according to claim 4, wherein the manganese (II) acetate is present in an amount ranging from 1 mole to 3 moles, based on 1 kilogram of the water.

6. An aqueous electrolyte formed by mixing water and a salt component of an aqueous electrolyte composition as claimed in claim 1 to undergo a solvation process, comprising:
[Zn(H₂O)₆]²⁺ ion cluster;
[ZnCl₂₊ₓ(H₂O)ₙ]^{x-} ion cluster, wherein x represents an integer ranging from 0 to 3, and n represents an integer ranging from 1 to 4; and
[Mn(CH₃COO)_{2+y}(H₂O)ₘ]^{y-} ion cluster, wherein y represents an integer ranging from 0 to 3, and m represents an integer ranging from 1 to 4.

7. A zinc ion secondary battery, comprising a manganese positive electrode, a negative electrode spaced apart from the manganese positive electrode, and an aqueous electrolyte as claimed in claim 6 in contact with the manganese positive electrode and the negative electrode.

8. The zinc ion secondary battery according to claim 7, wherein the negative electrode is selected from the group consisting of a zinc negative electrode, a copper negative electrode, a lead negative electrode, a tungsten negative electrode, and an indium negative electrode.

9. An aqueous electrolyte composition, comprising:
water; and
a salt component which includes zinc chloride, manganese (II) salt, and acetate, the acetate being selected from the group consisting of sodium acetate, potassium acetate, lithium acetate, magnesium acetate, calcium acetate, and combinations thereof, the manganese (II) salt being selected from the group consisting of manganese (II) chloride, manganese nitrate, manganese sulfate, manganese I) perchlorate, manganese (II) bis(trifluoromethanesulfonyl)imide, and combinations thereof;
wherein the zinc chloride is present in an amount ranging from 10 moles to 30 moles, based on 1 kilogram of the water.

10. The aqueous electrolyte composition according to claim 9, wherein the zinc chloride is present in an amount ranging from 19 moles to 30 moles, based on 1 kilogram of the water.

11. The aqueous electrolyte composition according to claim 9, wherein the acetate is present in an amount ranging from 1 mole to 10 moles, based on 1 kilogram of the water.

12. The aqueous electrolyte composition according to claim 11, wherein the acetate is present in an amount ranging from 2 moles to 4 moles, based on 1 kilogram of the water.

13. The aqueous electrolyte composition according to claim 9, wherein the manganese (II) salt is present in an amount ranging from 0.5 moles to 5.0 moles, based on 1 kilogram of the water.

14. The aqueous electrolyte composition according to claim 13, wherein the manganese (II) salt is present in an amount ranging from 0.5 moles to 1.0 mole, based on 1 kilogram of the water.

15. An aqueous electrolyte formed by mixing water and a salt component of an aqueous electrolyte composition as claimed in claim 9 to undergo a solvation process, comprising:
[Zn(H₂O)₆]²⁺ ion cluster;
[ZnCl₂₊ₓ(H₂O)ₙ]^{x-} ion cluster, wherein x represents an integer ranging from 0 to 3, and n represents an integer ranging from 1 to 4; and
[Mn(CH₃COO)_{2+y}(H₂O)ₘ]^{y-} ion cluster, wherein y represents an integer ranging from 0 to 3, and m represents an integer ranging from 1 to 4.

16. A zinc ion secondary battery, comprising a manganese positive electrode, a negative electrode spaced apart from the manganese positive electrode, and an aqueous electrolyte as claimed in claim 15 in contact with the manganese positive electrode and the negative electrode.

17. The zinc ion secondary battery according to claim 16, wherein the negative electrode is selected from the group consisting of a zinc negative electrode, a copper negative electrode, a lead negative electrode, a tungsten negative electrode, and an indium negative electrode.
